(19) United States
(12) Patent Application Publication
(10) Pub. No.: US 2024/0186072 A1
(43) Pub. Date: Jun. 6, 2024

(54) CAPACITOR ELEMENT

(71) Applicant: Murata Manufacturing Co., Ltd., Nagaokakyo-shi (JP)

(72) Inventors: Masanori YOSHIKAWA, Nagaokakyo-shi (JP); Takeshi FURUKAWA, Nagaokakyo-shi (JP)

(21) Appl. No.: 18/439,965

(22) Filed: Feb. 13, 2024

Related U.S. Application Data
(63) Continuation of application No. PCT/JP22/27246, filed on Jul. 11, 2022.

(30) Foreign Application Priority Data
Aug. 18, 2021 (JP) 2021-133302

(51) Int. Cl. H01G 9/048; H01G 9/025

(52) U.S. Cl. CPC H01G 9/048; H01G 9/025

(57) ABSTRACT

A capacitor element having a cathode region and an anode region in a plan view thereof, the capacitor element including: an anode plate in at least the anode region; a porous portion composed of a valve metal in the cathode region and not in the anode region; a dielectric layer on a surface of the porous portion in the cathode region; and a cathode layer on a surface of the dielectric layer in the cathode region, the cathode layer including a solid-electrolyte layer.

### CROSS REFERENCE TO RELATED APPLICATIONS

The present application is a continuation of International application No. PCT/JP2022/027246, filed Jul. 11, 2022, which claims priority to Japanese Patent Application No. 2021-133302, filed Aug. 18, 2021, the entire contents of each of which are incorporated herein by reference.

### TECHNICAL FIELD

The present invention relates to a capacitor element.

### BACKGROUND ART

Patent Document 1 discloses a solid-electrolyte capacitor array that includes a capacitor element group including a plurality of capacitor elements. The solid-electrolyte capacitor array also includes one or more anode terminals connected to and extended from each of one or more anode leads of the capacitor elements of this capacitor element group, one or more cathode terminals connected to and extended from cathode layers of the capacitor elements, and an exterior resin layer covering the capacitor elements. The anode terminals and the cathode terminals are configured as outer terminals.
Patent Document 1: Japanese Unexamined Patent Application Publication No. 2004-281750

### SUMMARY OF THE INVENTION

According to Patent Document 1, using an array structure in which the plurality of capacitor elements are connected to the anode terminals and the cathode terminals can facilitate the manufacture of the solid-electrolyte capacitor array that realizes a low equivalent series resistance (ESR) and a low equivalent series inductance (ESL) and has good radio frequency characteristics.

However, when the plurality of capacitor elements are formed in an array shape by using the method described in Patent Document 1, it is required that the capacitor elements having been formed in advance be connected to each other. Consequently, there arise problems such as an increase in likelihood of complication of a manufacturing process and reduction of volumetric capacitance density of the entire capacitor array.

As described above, it is not easy to connect the capacitor elements to each other in addition to ensuring a high volumetric capacitance density in the capacitor array described in Patent Document 1. Herein, when a region in which a capacitor is formed is defined as a cathode region and a region in which a capacitor is not formed is defined as an anode region, in the capacitor array including the plurality of capacitor elements, a region occupied by an individual capacitor element corresponds to the cathode region, and a region between adjacent capacitor elements corresponds to the anode region.

As described above, it can be said that it is difficult to form the cathode region and the anode region in the capacitor array including the plurality of capacitor elements. The problem in that it is difficult to form the cathode region and the anode region is not limited to a case where the plurality of capacitor elements are connected to each other for fabricating the capacitor array. This problem also arises in a case where the cathode region and the anode region are formed in a single capacitor element.

An object of the present invention is to provide a capacitor element for which a cathode region and an anode region can be easily formed.

A capacitor element according to the present invention has a cathode region and an anode region in plan view thereof, and the capacitor element includes: an anode plate in at least the anode region; a porous portion composed of a valve metal in the cathode region and not in the anode region; a dielectric layer on a surface of the porous portion in the cathode region; and a cathode layer on a surface of the dielectric layer in the cathode region, the cathode layer including a solid-electrolyte layer.

According to the present invention, it is possible to provide the capacitor element for which the cathode region and the anode region can be easily formed.

### BRIEF DESCRIPTION OF THE DRAWINGS

FIG. 1A is a sectional view schematically illustrating an example of a capacitor element according to a first embodiment of the present invention.

FIG. 1B is a plan view taken along line B-B of FIG. 1A.

FIG. 2 is a sectional view schematically illustrating another example of the capacitor element according to the first embodiment of the present invention.

FIG. 3 is a sectional view schematically illustrating an example of the capacitor element in which an insulating layer is provided in an anode region.

FIG. 4 is a sectional view schematically illustrating another example of the capacitor element in which the insulating layer is provided in the anode region.

FIG. 5 is a sectional view schematically illustrating an example of a capacitor element in which an anode plate does not include a core portion in cathode regions.

FIG. 6 is a sectional view schematically illustrating an example of the capacitor element in which a through hole conductor is provided in the anode region.

FIG. 7 is a sectional view schematically illustrating another example of the capacitor element in which the through hole conductor is provided in the anode region.

FIG. 8 is a sectional view schematically illustrating an example of the capacitor element in which a slit is provided in the anode plate.

FIG. 9 is a plan view schematically illustrating an example of the anode plate part of which has undergone an etching process.

FIG. 10 is a sectional view schematically illustrating the example of the anode plate the part of which has undergone the etching process.

FIG. 11 is a sectional view schematically illustrating an example of the anode plate on which dielectric layers are formed.

FIG. 12 is a sectional view schematically illustrating an example of the anode plate above which the cathode layers are formed.

FIG. 13A is a sectional view schematically illustrating an example of a capacitor element according to a second embodiment of the present invention.

FIG. 13B is a plan view taken along line B-B of FIG. 13A.

FIG. 14A is a sectional view schematically illustrating another example of the capacitor element according to the second embodiment of the present invention.

FIG. 14B is a plan view taken along line B-B of FIG. 14A.

FIG. 15 is a plan view schematically illustrating a modification of arrangement of the through hole conductors in the capacitor element according to the second embodiment of the present invention.

### DETAILED DESCRIPTION OF THE PREFERRED EMBODIMENTS

Hereinafter, a capacitor element according to the present invention will be described.

However, the present invention is not limited to the following configurations and can be applied with appropriate changes without changing the gist of the present invention. A combination of two or more desirable individual configurations of the present invention to be described below is also the present invention.

The drawings to be referred to below are schematic diagrams, and the scales of aspect ratios, the dimensions, and the like of the drawings may be different from those of an actual product.

### [Capacitor Element]

### First Embodiment

In a capacitor element according to a first embodiment of the present invention, an anode region is provided so as to keep adjacent cathode regions separated from each other. The capacitor element according to the first embodiment of the present invention may have two or more sets of the adjacent cathode regions. In this case, it is sufficient that the anode region be provided so as keep at least one set of the adjacent cathode regions separated from each other. Since the capacitor element according to the first embodiment of the present invention has a plurality of the cathode regions, the capacitor element can be referred to as a capacitor array.

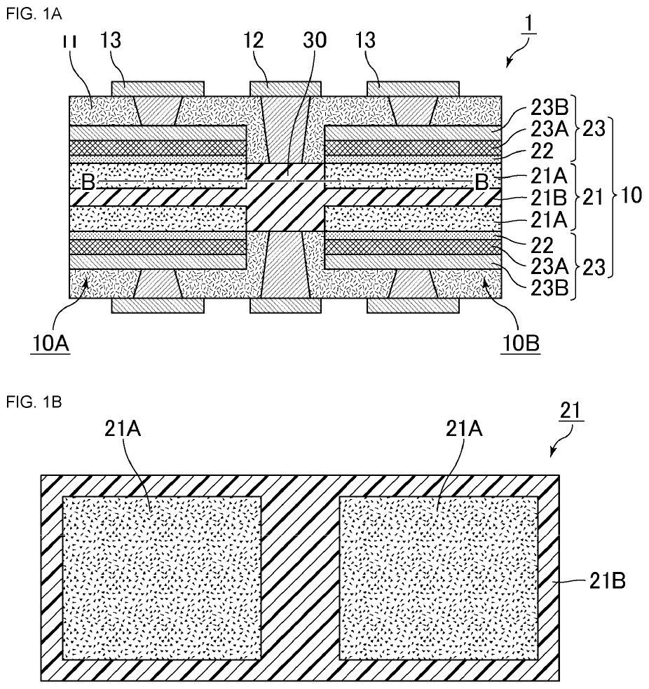

FIG. 1A is a sectional view schematically illustrating an example of the capacitor element according to the first embodiment of the present invention. FIG. 1B is a plan view taken along line B-B of FIG. 1A.

A capacitor element 1 illustrated in FIG. 1A generally has a sheet shape. The capacitor element 1 has cathode regions 10 and an anode region 30 in plan view of a main surface. As illustrated in FIG. 1A, the capacitor element 1 has a plurality of the cathode regions 10 (for example, cathode regions 10A and 10B).

The number of cathode regions 10 included in the capacitor element 1 is not particularly limited as long as two or more cathode regions 10 are included. The size, shape, and the like of the cathode regions 10 may be the same, or a subset or the entirety of the size, shape, and the like of the cathode regions 10 may be different.

The capacitor element 1 includes an anode plate 21 illustrated in FIG. 1B. The capacitor element 1 includes, in each of the cathode regions 10, a porous portion 21A provided in at least one of main surfaces of the anode plate 21 formed of a valve metal, a dielectric layer 22 provided on a surface of the porous portion 21A, and a cathode layer 23 that is provided on a surface of the dielectric layer 22 and includes a solid-electrolyte layer 23A. In each cathode region 10, the anode plate 21 includes, for example, a core portion 21B and the porous portion 21A provided in at least one of main surfaces of the core portion 21B. In the cathode region 10, the cathode layer 23 includes, for example, the solid-electrolyte layer 23A provided on the surface of the dielectric layer 22 and a conductor layer 23B provided on a surface of the solid-electrolyte layer 23A.

The capacitor element 1 may further include a sealing layer 11 provided so as to cover the cathode regions 10 and the anode region 30.

The capacitor element 1 may further include outer electrodes 12 and 13. For example, the first outer electrode 12 is electrically connected to the core portion 21B of the anode plate 21 in the anode region 30, and the second outer electrodes 13 are electrically connected to the conductor layers 23B of the cathode layers 23 in the cathode regions 10. When the capacitor element 1 includes the sealing layer 11, the first outer electrode 12 and the second outer electrodes 13 are provided in an outer side portion of the sealing layer 11. A form through which the first outer electrode 12 and the core portion 21B of the anode plate 21 are connected to each other is not particularly limited. The first outer electrode 12 and the core portion 21B may be connected through a via conductor or a through hole conductor. Likewise, a form through which the second outer electrodes 13 and the conductor layer 23B of the cathode layer 23 are connected to each other is not particularly limited. The second outer electrodes 13 and the conductor layer 23B may be connected through via conductors or through hole conductors.

Preferably, the structures of the cathode region 10A and the cathode region 10B are the same. Furthermore, when the capacitor element 1 includes the sealing layer 11, the distance between a surface of the sealing layer 11 and the anode plate 21 included in each of the cathode regions 10 are preferably uniform.

In the anode region 30, the porous portion 21A is not provided in part of the one of the main surfaces of the anode plate 21. In the example illustrated in FIG. 1A, the anode region 30 is provided between the adjacent cathode regions 10A and 10B. For example, as illustrated in FIG. 1A, the anode region 30 includes only the core portion 21B of the anode plate 21 and does not include the porous portion 21A in the thickness direction (the up-down direction in FIG. 1A).

Referring to FIG. 1B, portions where the porous portions 21A are provided correspond to the cathode regions 10, and a portion where the porous portion 21A is not provided and the core portion 21B is exposed corresponds to the anode region 30. Accordingly, in the capacitor element 1 illustrated in FIG. 1A, the anode region 30 is provided so as to keep the adjacent cathode regions 10 to be separated from each other. In other words, the plurality of cathode regions 10 (for example, the cathode regions 10A and 10B) share the anode region 30.

The porous portions 21A can be formed by, for example, performing an etching process on a surface of the anode plate 21. Accordingly, the porous portions 21A are normally provided uniformly on the surface of the anode plate 21. In contrast, part not etched can be utilized as the anode region 30 by performing the etching process on parts of the surface of the anode plate 21.

In the case of forming the cathode layer 23 included in each of the cathode regions 10 on the surface of the anode plate 21 where the porous portions 21A are uniformly provided as in the related art, it is required that the porous portion 21A between the adjacent cathode regions 10 be removed in some way or pores of the porous portion 21A be filled with an insulating material or the like. Accordingly, there arise problems in that, for example, spacing between the adjacent cathode regions 10 increases, manufacturing processes become complicated. In contrast, when the anode region 30 that includes only the core portion 21B and does not to include the porous portion 21A in the thickness direction is provided in the anode plate 21, the adjacent cathode regions 10 can be easily kept separated from each other by forming the cathode layers 23 in regions where the porous portions 21A are discontinuous with the anode region 30 interposed between the porous portions 21A. Accordingly, the cathode regions 10 and the anode region 30 can be easily formed.

Preferably, as illustrated in FIG. 1A, an outer electrode (the first outer electrode 12 in FIG. 1A) electrically connected to the core portion 21B of the anode plate 21 is provided in the anode region 30.

In this case, preferably, no porous portion 21A is provided in a region of the core portion 21B to which the first outer electrode 12 is electrically connected in the anode region 30.

In the anode region 30, the core portion 21B may be electrically connected directly to the first outer electrode 12. Alternatively, in the anode region 30, another member is provided between the core portion 21B and the first outer electrode 12. For example, in the anode region 30, a plating process may be performed on a region on the core portion 21B side between the core portion 21B and the first outer electrode 12.

As illustrated in FIG. 1A, for example, the anode region 30 can be utilized as an anode portion of the capacitor element 1. Alternatively, as will be described later, the anode region 30 can be utilized as a portion to be processed for forming a slit or the like in the anode plate 21.

In the example illustrated in FIG. 1A, the anode region 30 is provided between the cathode region 10A and the cathode region 10B. As described above, referring to FIG. 1B, the portions where the porous portions 21A are provided correspond to the cathode regions 10, and the portion where the porous portion 21A is not provided and the core portion 21B is exposed corresponds to the anode region 30.

Accordingly, as illustrated in FIG. 1B, the anode region 30 may be provided so as to surround the cathode layer 23 included in the cathode region 10A as viewed in the thickness direction. Likewise, the anode region 30 may be provided so as to surround the cathode layer 23 included in the cathode region 10B as viewed in the thickness direction.

Preferably, a region including the porous portion 21A is not provided in the thickness direction between the cathode layer 23 included in the cathode region 10A and the cathode layer 23 included in the cathode region 10B. That is, preferably, the anode region 30 is uniformly provided between the adjacent cathode regions 10.

As described above, the anode region 30 and the porous portions 21A included in the cathode regions 10 can be formed in a collective manner by performing the etching process in parts of the surface of the anode plate 21. Accordingly, the anode region 30 and the cathode regions 10 are preferably integral with each other. For example, the anode region 30 is preferably integral with the cathode region 10A. In particular, in a case where the anode plate 21 included in the cathode region 10A includes the core portion 21B, the core portion 21B included in the anode region 30 is preferably integral with the core portion 21B included in the cathode region 10A. Likewise, the anode region 30 is preferably integral with the cathode region 10B. In particular, in a case where the anode plate 21 included in the cathode region 10B includes the core portion 21B, the core portion 21B included in the anode region 30 is preferably integral with the core portion 21B included in the cathode region 10B.

As in the capacitor element 1 illustrated in FIG. 1A, the anode region 30 may be provided up to the positions of the surfaces of the porous portions 21A in the cathode regions 10. In this case, since the core portion 21B of the anode plate 21 in the anode region 30 is drawn to the positions of the surfaces of the porous portions 21A in the cathode regions 10, versatility of design for connection between the anode plate 21 and the first outer electrode 12 can be improved.

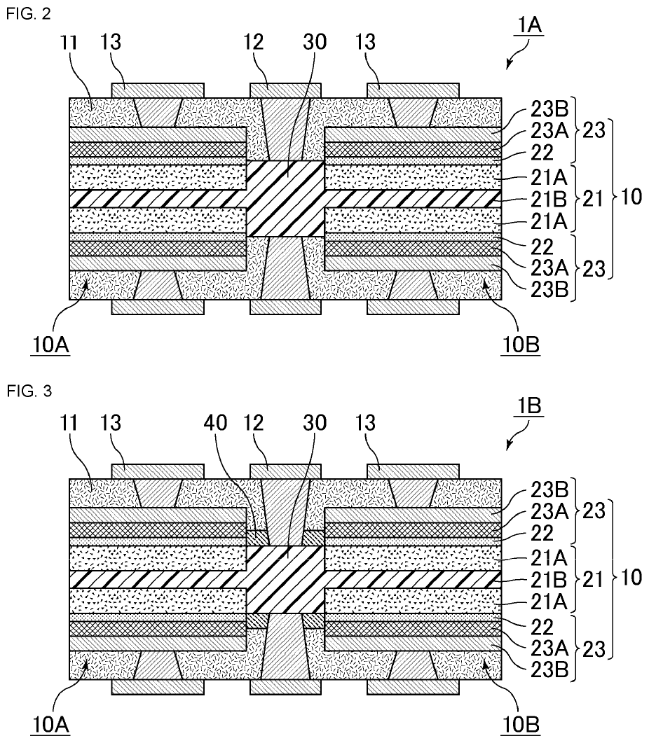

FIG. 2 is a sectional view schematically illustrating another example of the capacitor element according to the first embodiment of the present invention.

As in a capacitor element 1A illustrated in FIG. 2, the anode region 30 may be provided at the position higher than the surfaces of the porous portions 21A in the cathode regions 10. In this case, preferably, the anode region 30 is provided at the position higher than the surfaces of the porous portions 21A in the cathode regions 10 by greater than or equal to 10% of the total thickness of the porous portions 21A. In contrast, preferably, the anode region 30 is provided at the position higher than the surfaces of the porous portions 21A in the cathode regions 10 by smaller than or equal to 50% of the total thickness of the porous portions 21A.

In order to form the solid-electrolyte layers 23A of the cathode layers 23 on the fine surfaces of the porous portions 21A in the cathode regions 10, it is required that the wettability of the porous portions 21A to a solid electrolyte included in the solid-electrolyte layers 23A be satisfactory. Since the core portion 21B included in the anode region 30 has a similar wettability to that of the porous portions 21A in the cathode regions 10, the solid-electrolyte layers 23A may be formed so as to extend through the adjacent cathode regions 10. Thus, when the positions of the surfaces of the porous portions 21A in the cathode regions 10 are made to be lower than the anode region 30, the extension of the solid-electrolyte layers 23A between the cathode regions 10 can be suppressed.

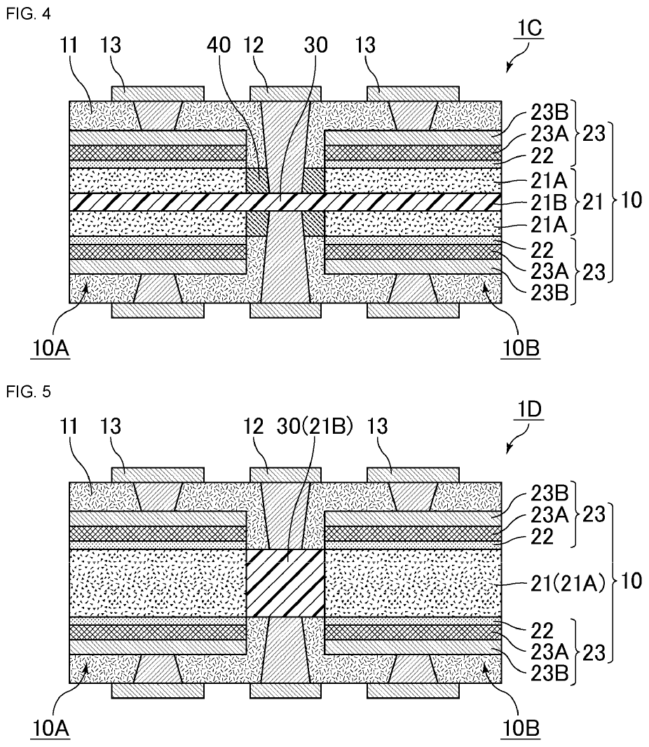

As in a capacitor element 1C illustrated in FIG. 4 to be described later, the anode region 30 may be provided at the positions lower than the surfaces of the porous portions 21A in the cathode regions 10. In this case, the thickness of the core portion 21B included in the anode region 30 is, for example, equivalent to the thickness of the core portion 21B in the cathode regions 10.

FIG. 3 is a sectional view schematically illustrating an example of the capacitor element in which an insulating layer is provided in the anode region. FIG. 4 is a sectional view schematically illustrating another example of the capacitor element in which an insulating layer is provided in the anode region.

As in a capacitor element 1B illustrated in FIG. 3 and the capacitor element 1C illustrated in FIG. 4, an insulating layer 40 may be provided on at least one of the main surfaces of the anode plate 21 in the anode region 30. For example, the insulating layer 40 may be provided on at least one of the main surfaces of the core portion 21B included in the anode region 30.

In the capacitor element 1B illustrated in FIG. 3, the anode region 30 may be provided up to the positions of the surfaces of the porous portions 21A in the cathode regions 10 or at a position higher than the surfaces of the porous portions 21A in the cathode regions 10.

In the capacitor element 1C illustrated in FIG. 4, the anode region 30 is provided at a position lower than the surfaces of the porous portions 21A in the cathode regions 10. The thickness of the core portion 21B included in the anode region 30 is, for example, equivalent to the thickness of the core portion 21B included in the cathode regions 10.

As illustrated in FIGS. 3 and 4, insulation between the anode plate 21 and the cathode layers 23 can be improved by providing the insulating layer 40 on at least one of the main surfaces of the anode plate 21 in the anode region 30.

When the insulating layer 40 is provided on the at least one of the main surfaces of the anode plate 21 in the anode region 30, part of the insulating layer 40 preferably fills the pores of the porous portions 21A in the cathode regions 10. For example, when, in at least one of the adjacent cathode regions 10, the insulating layer 40 is provided so as to fill in the pores of the porous portions 21A in the cathode region 10, the likelihood of peeling off of the insulating layer 40 reduces due to an anchoring effect.

FIG. 5 is a sectional view schematically illustrating an example of a capacitor element in which the anode plate does not include the core portion in the cathode regions.

As in a capacitor element 1D illustrated in FIG. 5, the anode plate 21 may include only the porous portions 21A and does not necessarily include the core portion 21B in the thickness direction in the cathode regions 10. Although the anode plate 21 includes only the porous portions 21A in all the cathode regions 10 in the example illustrated in FIG. 5, the anode plate 21 may include only the porous portion 21A in at least one of the cathode regions 10. The anode region 30 including only the core portion 21B having a higher strength than that of the porous portions 21A is provided between the adjacent cathode regions 10. Accordingly, even when the anode plate 21 included in the at least one of the cathode regions 10 does not include the core portion 21B, the cathode regions 10 can be supported by the anode region 30. In addition, capacitance density per unit volume can be improved by making the anode plate 21 included in the at least one of the cathode regions 10 completely porous.

In the capacitor element 1D illustrated in FIG. 5, the anode region 30 may be provided up to the positions of the surfaces of the porous portions 21A in the cathode regions 10, at a position higher than the surfaces of the porous portions 21A in the cathode regions 10, or at a position lower than the surfaces of the porous portions 21A in the cathode regions 10. Furthermore, in the anode region 30, the insulating layer 40 may be provided on at least one of the main surfaces of the anode plate 21.

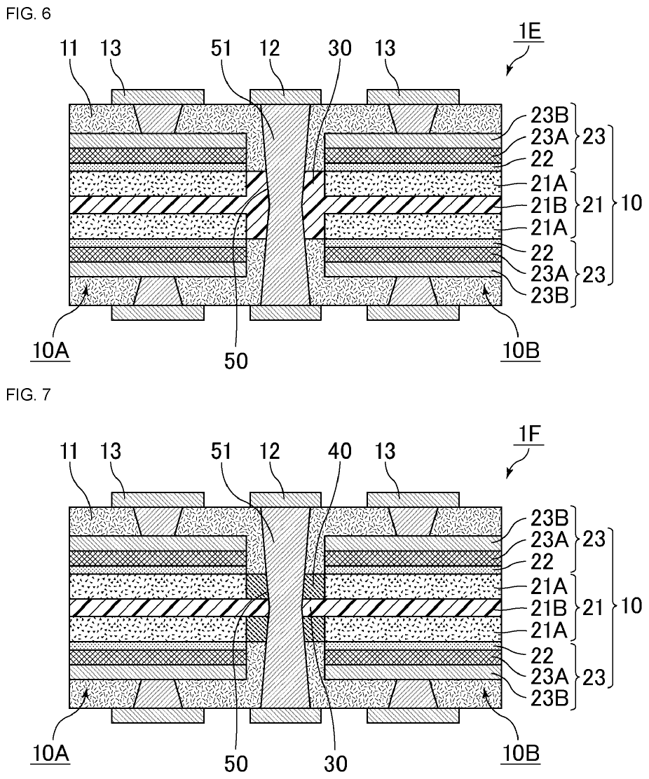

FIG. 6 is a sectional view schematically illustrating an example of the capacitor element in which a through hole conductor is provided in the anode region. FIG. 7 is a sectional view schematically illustrating another example of the capacitor element in which the through hole conductor is provided in the anode region.

As in a capacitor element 1E illustrated in FIG. 6 and a capacitor element 1F illustrated in FIG. 7, a through hole 50 may be formed so as to extend through the anode region 30 in the thickness direction, and a through hole conductor 51 that extends in the thickness direction may be provided in the through hole 50.

The through hole conductor 51 is, for example, electrically connected to the anode plate 21. The through hole conductor 51 is, for example, electrically connected to the anode plate 21 of the adjacent cathode regions 10A and 10B. In this case, as illustrated in FIGS. 6 and 7, in the anode region 30, preferably, the through hole conductor 51 is electrically connected to the anode plate 21 of the adjacent cathode regions 10A and 10B by connecting the through hole conductor 51 to the core portion 21B of the anode plate 21 at an inner wall of the through hole 50.

In a case where the anode plate 21 is directly drawn to the inner wall of the through hole 50, when the porous portions 21A are exposed in the wall surface of the through hole 50, it is required to prevent the through hole conductor 51 from being connected to, due to capillary action, significant parts of the cathode regions 10. In contrast, as illustrated in FIGS. 6 and 7, when the through hole 50 is formed so as to extend through the anode region 30 in the thickness direction, the core portion 21B is exposed in the wall surface of the through hole 50. Accordingly, there is no possibility that the through hole conductor 51 is connected to the significant parts of the cathode regions 10. In particular, as the thickness of the anode region 30 increases, connection reliability can be improved.

In the capacitor element 1E illustrated in FIG. 6, the anode region 30 may be provided up to the positions of the surfaces of the porous portions 21A in the cathode regions 10 or at a position higher than the surfaces of the porous portions 21A in the cathode regions 10. Furthermore, in the anode region 30, the insulating layer 40 may be provided on at least one of the main surfaces of the anode plate 21.

In the capacitor element 1F illustrated in FIG. 7, the anode region 30 is provided at a position lower than the surfaces of the porous portions 21A in the cathode regions 10. The thickness of the core portion 21B included in the anode region 30 is, for example, equivalent to the thickness of the core portion 21B in the cathode regions 10. Alternatively, the sealing layer 11 may be filled instead of the insulating layer 40.

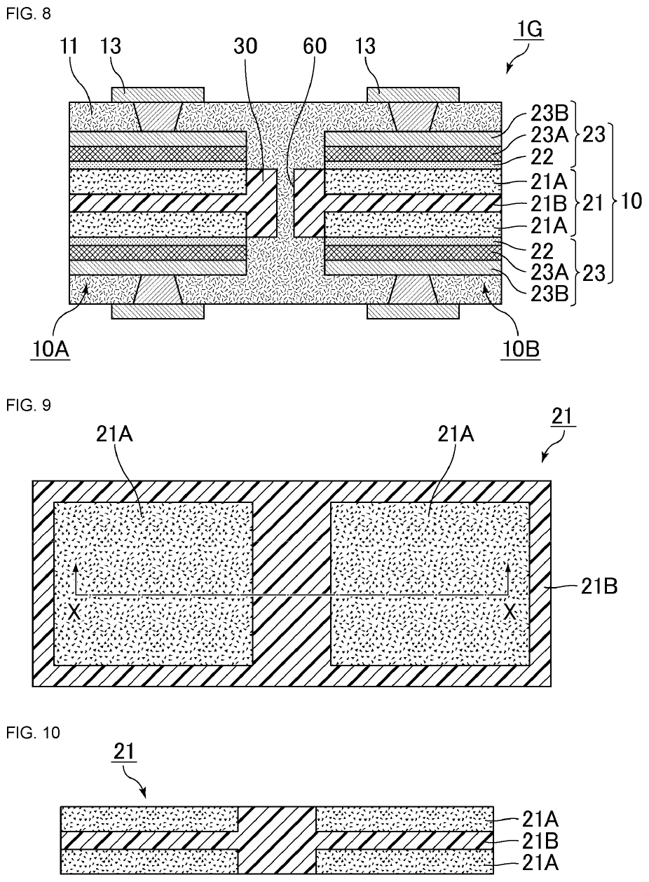

FIG. 8 is a sectional view schematically illustrating an example of the capacitor element in which a slit is provided in the anode plate.

As in a capacitor element 1G illustrated in FIG. 8, a slit 60 may be formed so as to extend through the anode plate 21 in the thickness direction in the anode region 30. The anode region 30 is divided by the slit 60 between the adjacent cathode regions 10. The anode region 30 may be divided physically or electrically between the adjacent cathode regions 10. The inside of the slit 60 is filled with, for example, the sealing layer 11.

In the capacitor element 1G illustrated in FIG. 8, the anode region 30 may be provided up to the positions of the surfaces of the porous portions 21A in the cathode regions 10, at a position higher than the surfaces of the porous portions 21A in the cathode regions 10, or at a position lower than the surfaces of the porous portions 21A in the cathode regions 10. Furthermore, in the anode region 30, the insulating layer 40 may be provided on at least one of the main surfaces of the anode plate 21. In this case, for example, the inside of the slit 60 is filled with the insulating layer 40.

The anode plate 21 is formed of a valve metal exhibiting so-called valve action. Examples of the valve metal include, for example, an element metal such as aluminum, tantalum, niobium, titanium, and zirconium or an alloy or the like including these metals. Out of these metals, aluminum or an aluminum alloy is preferred.

The shape of the anode plate 21 is preferably a plate shape and more preferably a foil shape.

In the cathode regions 10, the anode plate 21 may include the core portion 21B and the porous portions 21A provided in at least one of the main surfaces of the core portion 21B, or the anode plate 21 may include only the porous portions 21A and does not include the core portion 21B in the thickness direction. When the anode plate 21 includes the core portion 21B in the cathode regions 10, it is sufficient that the porous portions 21A be included in at least one of the main surfaces of the core portion 21B. Alternatively, the porous portions 21A may be included in both the main surfaces of the core portion 21B. The porous portions 21A are preferably etched layers formed in at least the surfaces of the anode plate 21.

Preferably, the thickness of the anode plate 21 before the etching process is greater than or equal to 60 μm and smaller than or equal to 200 μm. Preferably, the thickness of the core portion 21B not etched after the etching process in the cathode regions 10, that is, the thickness of the core portion 21B in a region other than the anode region 30 is greater than or equal to 15 μm and smaller than or equal to 70 μm. Although the thickness of the porous portions 21A in the cathode regions 10 is designed in accordance with a required withstand voltage and electrostatic capacitance, the total of the thicknesses of the porous portions 21A on both sides of the core portion 21B is preferably greater than or equal to 10 μm and smaller than or equal to 180 μm. As described above, the anode plate 21 may include only the porous portions 21A in the cathode regions 10.

Preferably, the diameter of the pores of the porous portions 21A is greater than or equal to 10 nm and smaller than or equal to 600 nm. The diameter of the pores of the porous portions 21A means a median size D50 measured by a mercury porosimeter. The diameter of the pores of the porous portions 21A can be controlled by, for example, adjusting various conditions in the etching.

The dielectric layers 22 are provided on the surfaces of the porous portions 21A. The dielectric layers 22 are porous by reflecting a surface state of the porous portions 21A and have a surface shape having fine irregularities. Preferably, the dielectric layers 22 are formed of oxide films of the above-described valve metal. For example, when an aluminum foil is used as the anode plate 21, the dielectric layers made of oxide films can be formed by performing anodizing (also referred to as chemical conversion) on the surface of the aluminum foil in an aqueous solution including adipic acid ammonium or the like.

Although the thickness of the dielectric layers 22 is designed in accordance with a required withstand voltage and electrostatic capacitance, the thickness of the dielectric layers 22 is preferably greater than or equal to 10 nm and smaller than or equal to 100 nm.

The dielectric layer 22 may be provided on the surface of the anode region 30 or is not necessarily provided on the surface of the anode region 30.

The cathode layers 23 are provided on the surfaces of the dielectric layers 22. The cathode layers 23 include the solid-electrolyte layers 23A provided on the surfaces of the dielectric layers 22. Preferably, the cathode layers 23 further include the conductor layers 23B provided on the surfaces of the solid-electrolyte layers 23A.

Examples of the material included in the solid-electrolyte layers 23A include, for example, conductive polymers or the like such as a polypyrrole class, a polythiophene class, and a polyaniline class. Out of these, the polythiophene class is preferable, and a poly(3,4-ethylenedioxythiophene) called PEDOT is particularly preferable. The above-described conductive polymers may include dopant such as poly(styrene-sulfonic acid) (PSS). Preferably, the solid-electrolyte layers 23A include inner layers filled in the pores (recessed portions) of the dielectric layers 22 and outer layers covering the dielectric layers 22.

Preferably, the thickness of the solid-electrolyte layers 23A from the surfaces of the porous portions 21A is greater than or equal to 2 μm and smaller than or equal to 20 μm.

The solid-electrolyte layers 23A are formed by, for example, a method in which polymer films of poly(3,4-ethylenedioxythiophene) or the like are formed on the surfaces of the dielectric layers 22 by using a processing liquid including a monomer such as 3,4-ethylenedioxythiophene, a method in which a dispersant of a polymer such as poly(3,4-ethylenedioxythiophene) is applied onto the surfaces of the dielectric layers 22 and dried, or the like.

The solid-electrolyte layers 23A can be formed in predetermined regions by applying the above-described processing liquid or the dispersant onto the dielectric layers 22 by a method such as sponge transfer, screen printing, dispenser coating, or ink-jet printing.

The conductor layers 23B each include at least one of a conductive resin layer or a metal layer. The conductor layer 23B may include only the conductive resin layer or the metal layer. Preferably, the conductor layers 23B cover the entire surfaces of the solid-electrolyte layers 23A.

Examples of the conductive resin layer include, for example, a conductive adhesive layer and the like including at least one conductive filler selected from the group consisting of a silver filler, a copper filler, a nickel filler, and a carbon filler.

Examples of the metal layer include, for example, a metal plating film, a metal foil, and the like. Preferably, the metal layer is formed of at least one metal selected from the group consisting of nickel, copper, silver, and an alloy including these metals as a principal component. The “principal component” refers to an elemental component of a largest weight ratio.

The conductor layers 23B include, for example, carbon layers provided on the surfaces of the solid-electrolyte layers 23A and copper layers provided on surfaces of the carbon layers.

The carbon layers are provided so as to electrically and mechanically connect the solid-electrolyte layers 23A and the copper layers to each other. The carbon layers can be formed in predetermined regions by applying carbon paste onto the solid-electrolyte layers 23A by a method such as sponge transfer, screen printing, dispenser coating, or ink-jet printing. Preferably, when the copper layers are laminated in the following step, the carbon layers are in a viscous state before drying. Preferably, the thickness of the carbon layers is greater than or equal to 2 μm and smaller than or equal to 20 μm.

The copper layers can be formed by printing copper paste on the carbon layers by a method such as sponge transfer, screen printing, spray coating, dispenser coating, or ink-jet printing. Preferably, the thickness of the copper layers is greater than or equal to 2 μm and smaller than or equal to 20 μm.

The cathode layers 23 included in the plurality of cathode regions 10 included in the capacitor element 1 or the like may be arranged in a linear manner or planar manner. The cathode layers 23 may be regularly or irregularly arranged. As viewed in the thickness direction, the size, planar shape, and the like of the cathode layers 23 may be the same, or a subset or the entirety of the size, planar shape, and the like of the cathode layers 23 may be different. Two or more types of the cathode layers 23 having different areas as viewed in the thickness direction may be included.

The capacitor element 1 or the like may include the cathode layer 23 having a planar shape other than a rectangle as viewed in the thickness direction. Herein, the “rectangle” means a square or a rectangle. Accordingly, the capacitor element 1 or the like may include the cathode layer 23 having a planar shape such as, for example, a quadrangle other than a rectangle, a triangle, a pentagon, a hexagon or another polygon, a shape including a curved part, a circle, or an ellipse. In this case, two or more types of the cathode layers 23 having different planar shapes may be included. Furthermore, in addition to the cathode layer 23 having a planar shape other than a rectangle, the capacitor element 1 or the like may include or does not necessarily include a cathode layer 23 having a rectangular planar shape.

When the capacitor element 1 or the like includes the sealing layer 11, the sealing layer 11 is provided so as to cover the cathode layers 23 included in the cathode regions 10. Sealing layers 11 may be provided so as to cover the cathode layers 23 from both main surface sides, or the sealing layer 11 may be provided so as to cover the cathode layers 23 from one of the main surface sides of the anode plate 21.

When the capacitor element 1 or the like includes the sealing layer 11, the slit 60 may be filled with the sealing layer 11. The anode plate 21 is reliably divided between the adjacent cathode regions 10 by the sealing layer 11.

Preferably, the sealing layer 11 is formed of resin. Examples of the resin included in the sealing layer 11 include, for example, epoxy resin, phenol resin, and the like. Preferably, the sealing layer 11 further includes a filler. Examples of the filler included in the sealing layer 11 include, for example, inorganic fillers such as a silica particle, alumina particle, and metallic particle.

The sealing layer 11 may include a single layer or two or more layers. When the sealing layer 11 includes two or more layers, the materials of the sealing layers may be the same or different.

Layers such as, for example, a stress reducing layer and a damp-proof layer may be provided between the cathode regions 10 and the sealing layer 11 or the anode region 30 and the sealing layer 11.

Preferably, the insulating layer 40 is formed of resin. Examples of the resin included in the insulating layer 40 include, for example, insulative resin such as polyphenylsulfone resin, polyethersulfone resin, cyanate ester resin, fluorocarbon resin (such as tetrafluoroethylene and tetrafluoroethylene/perfluoro (alkyl vinyl ether) copolymer), polyimide resin, polyamide-imide resin, epoxy resin, and derivatives or precursors of these.

The insulating layer 40 and the sealing layer 11 may be formed of the same resin. However, unlike the sealing layer 11, when an inorganic filler is included in the insulating layer 40, a significant part of the capacitor element may be adversely affected. Thus, the insulating layer 40 is preferably formed of a resin base only.

The insulating layer 40 can be formed by, for example, applying a mask material such as a composition including insulative resin onto the core portion 21B included in the anode region 30 by a method such as sponge transfer, screen printing, dispenser coating, or ink-jet printing.

The insulating layer 40 may be provided on the surfaces of the porous portions 21A or is not necessarily provided on the surfaces of the porous portions 21A.

When the through hole 50 is formed in the anode region 30, the sectional shape of the through hole 50 as viewed in the thickness direction is not particularly limited. The examples of the sectional shape of the through hole 50 include, for example, polygons including a quadrangle, a circle, an ellipse, and the like. The diameter of the hole refers to the diameter in a case where the sectional shape is a circle and the maximum length passing through the center of the section in a case where the sectional shape is other than a circle. The through hole 50 may have a tapered shape in which the diameter of the hole reduces in the thickness direction.

It is sufficient that the through hole conductor 51 provided inside the through hole 50 be provided at least on an inner wall surface of the through hole 50. The inner wall surface of the through hole 50 is metallized with a low resistance metal such as copper, gold, or silver. For ease of processing, for example, the inner wall surface can be metallized by electroless copper plating or electro copper plating. Metallizing of the through hole conductor 51 is not limited to a case where only the inner wall surface of the through hole 50 is metallized. Metal or a composite material of metal and resin or the like may be filled into the through hole 50.

The through hole conductor 51 is classified into (A) to (C) as follows: (A) for the anode of the capacitor; (B) for the cathode and the ground of the capacitor; and (C) for an I/O line. The through hole conductor 51 for the anode of the capacitor (A) is electrically connected to the anode plate 21, the through hole conductor 51 for the cathode and the ground of the capacitor (B) is electrically connected to the cathode layers 23, and the through hole conductor 51 for the I/O line (C) is not electrically connected to either the anode plate 21 or the cathode layers 23.

For the through hole conductor 51 for the anode of the capacitor (A), an insulating material may be filled into a space between the through hole 50 and the through hole conductor 51 or is not necessarily filled into the space between the through hole 50 and the through hole conductor 51. For the through hole conductor 51 for the cathode and the ground of the capacitor (B) and the through hole conductor 51 for the I/O line (C), the insulating material is filled into the space between the through hole 50 and the through hole conductor 51.

Regardless of whether the through hole conductor 51 is provided, a through hole conductor other than the through hole conductor 51 may be provided in a region other than the anode region 30. For example, a through hole conductor may be provided so as to extend through the cathode layer 23 in the thickness direction.

When the slit 60 is formed in the anode plate 21 in the anode region 30, although the width of the slit 60 is not particularly limited, the width of the slit 60 is preferably greater than or equal to 15 μm, more preferably greater than or equal to 30 μm, and still more preferably greater than or equal to 50 μm. Meanwhile, the width of the slit 60 is preferably smaller than or equal to 500 μm, more preferably smaller than or equal to 200 μm, and still more preferably smaller than or equal to 150 μm.

At least part of the slit 60 may be disposed so as not to extend through the entirety of the capacitor element 1 or the like. In this case, at least one cathode layer 23 may be disposed on a line that passes through the slit 60.

The slit 60 may have a tapered shape in which the width reduces in the thickness direction.

In the capacitor element according to the first embodiment of the present invention, when two or more sets of adjacent cathode regions are included, an anode region in which an anode plate is electrically connected may be provided between the adjacent cathode regions, or an anode region in which an anode plate is electrically divided may be provided between the adjacent cathode regions. Furthermore, as long as the anode region is provided between at least one set of the adjacent cathode regions, there may be a portion where the anode region is not provided between the adjacent cathode regions.

Preferably, the capacitor element according to the first embodiment of the present invention is manufactured as follows.

First, the etching process is performed on part of the surfaces of the anode plate 21.

FIG. 9 is a plan view schematically illustrating an example of the anode plate the part of which has undergone the etching process. FIG. 10 is a sectional view schematically illustrating the example of the anode plate the part of which has undergone the etching process. FIG. 10 is a sectional view taken along line X-X in the anode plate illustrated in FIG. 9.

For example, a resist layer (not illustrated) that covers a portion corresponding to the anode region 30 (see FIG. 1A) is formed on the surface of the anode plate 21, and the etching process is performed. In this way, as illustrated in FIGS. 9 and 10, the porous portions 21A are formed on parts of at least one of the main surfaces of the anode plate 21. In contrast, the portion covered by the resist layer includes only the core portion 21B and does not include the porous portion 21A in the thickness direction.

In the etching process, the height of the position of the surfaces of the porous portions 21A can be adjusted by adjusting an etching amount. The core portion 21B may remain, or only the porous portions 21A may be formed without allowing the core portion 21B to remain in the thickness direction in portions which are not covered by the resist layer and in which the porous portions 21A are formed.

Next, the dielectric layers 22 are formed on the surfaces of the porous portions 21A.

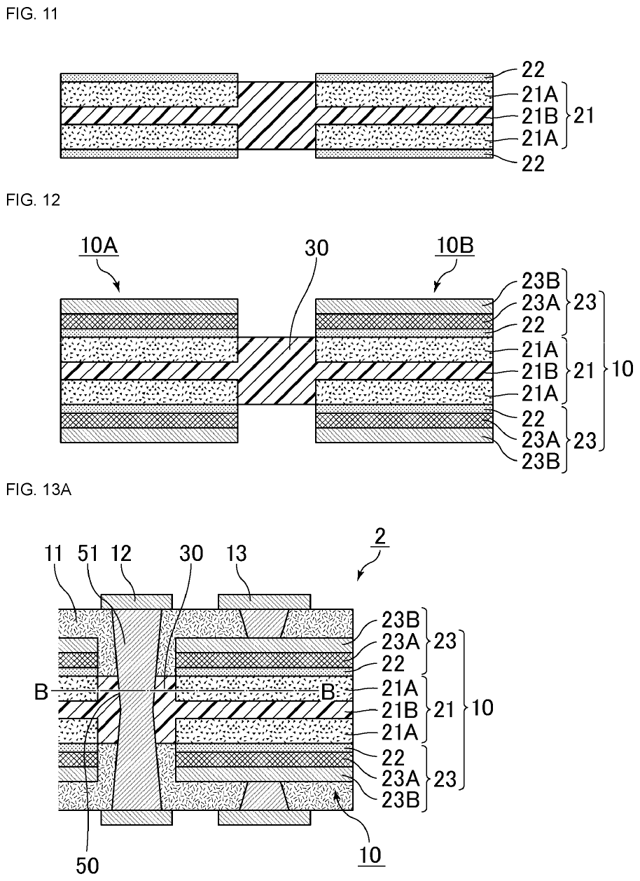

FIG. 11 is a sectional view schematically illustrating an example of the anode plate on which the dielectric layers are formed.

For example, when an aluminum foil is used as the anode plate 21, anodizing is performed in an aqueous solution including adipic acid ammonium or the like. In this way, as illustrated in FIG. 11, the dielectric layers 22 made of oxide films are formed on the surfaces of the porous portions 21A. The anodizing may be performed after the resist layer formed in the etching process has been removed, or the anodizing may be performed with the resist layer remaining.

Next, the cathode layers 23 are formed on the surfaces of the dielectric layers 22.

FIG. 12 is a sectional view schematically illustrating an example of the anode plate above which the cathode layers are formed.

As illustrated in FIG. 12, the solid-electrolyte layers 23A are formed on the surfaces of the dielectric layers 22 on the porous portions 21A. Preferably, the conductor layers 23B are formed on the surfaces of the solid-electrolyte layers 23A. In this way, the cathode layers 23 are formed on the surfaces of the dielectric layers 22 on the porous portions 21A.

Accordingly, the cathode regions 10 (for example, the cathode regions 10A and 10B) including the following portions and layers are formed: the porous portions 21A provided in at least one of the main surfaces of the anode plate 21; the dielectric layers 22 provided on the surfaces of the porous portions 21A; and the cathode layers 23 provided on the surfaces of the dielectric layers 22. Furthermore, the anode region 30 is formed between the adjacent cathode regions 10. In the examples illustrated in FIGS. 9 to 12, the anode region 30 is provided so as to surround each of the cathode layers 23 included in a corresponding one of the cathode regions 10 as viewed in the thickness direction.

In the anode region 30, the insulating layer 40 may be formed on at least one of the main surfaces of the anode plate 21.

After that, the sealing layer 11 may be formed so as to cover the cathode regions 10 and the anode region 30. For example, when an insulating material is provided by performing pressing, the sealing layer 11 can be formed so as to cover from one or both of the main surfaces of the anode plate 21.

According to need, the through hole 50 may be formed so as to extend through the anode region 30 in the thickness direction, and then, the through hole conductor 51 that extends in the thickness direction may be formed in the through hole 50. Examples of the method for forming the through hole 50 include, for example, laser machining, cutting with a dicing machine, and so forth.

Alternatively, the slit 60 may be formed so as to extend through the anode plate 21 in the thickness direction in the anode region 30. Examples of the method for forming the slit 60 include, for example, laser machining, cutting with a dicing machine, and so forth.

Accordingly, the capacitor element according to the first embodiment of the present invention can be manufactured.

### Second Embodiment

In a capacitor element according to a second embodiment of the present invention, the anode region is provided in the cathode region. The capacitor element according to the second embodiment of the present invention may have a plurality of cathode regions. In this case, it is sufficient that the anode region be provided in at least one of the cathode regions.

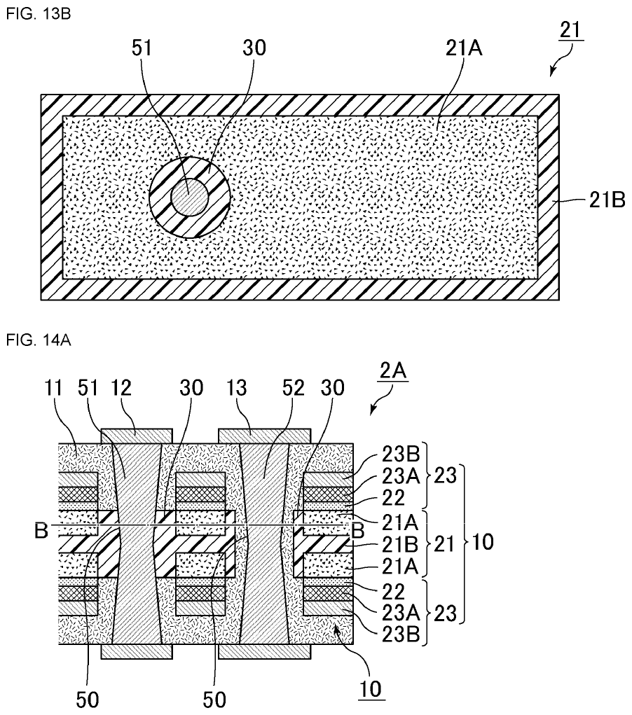

FIG. 13A is a sectional view schematically illustrating an example of the capacitor element according to the second embodiment of the present invention. FIG. 13B is a plan view taken along line B-B of FIG. 13A.

A capacitor element 2 illustrated in FIG. 13A generally has a sheet shape. The capacitor element 2 has the cathode region 10 and the anode region 30 in plan view of a main surface. In the example illustrated in FIG. 13A, the capacitor element 2 has a single cathode region 10.

The capacitor element 2 includes the anode plate 21 illustrated in FIG. 13B. The capacitor element 2 includes, in the cathode region 10, the porous portion 21A provided in at least one of the main surfaces of the anode plate 21 formed of a valve metal, the dielectric layer 22 provided on the surface of the porous portion 21A, and the cathode layer 23 that is provided on the surface of the dielectric layer 22 and includes the solid-electrolyte layer 23A. In the cathode region 10, the anode plate 21 includes, for example, the core portion 21B and the porous portion 21A provided in at least one of main surfaces of the core portion 21B. In the cathode region 10, the cathode layer 23 includes, for example, the solid-electrolyte layer 23A provided on the surface of the dielectric layer 22 and conductor layers 23B provided on the surface of the solid-electrolyte layer 23A.

The capacitor element 2 may further include the sealing layer 11 provided so as to cover the cathode region 10 and the anode region 30.

The capacitor element 2 may further include the outer electrodes 12 and 13. For example, the first outer electrode 12 is electrically connected to the core portion 21B of the anode plate 21 in the anode region 30, and the second outer electrode 13 is electrically connected to the conductor layer 23B of the cathode layer 23 in the cathode region 10. When the capacitor element 1 includes the sealing layer 11, the first outer electrode 12 and the second outer electrode 13 are provided in the outer side portion of the sealing layer 11.

In the anode region 30, the porous portion 21A is not provided in part of one of the main surfaces of the anode plate 21. For example, as illustrated in FIG. 13A, the anode region 30 includes only the core portion 21B of the anode plate 21 and does not include the porous portion 21A in the thickness direction (the up-down direction in FIG. 13A).

Referring to FIG. 13B, a portion where the porous portion 21A is provided corresponds to the cathode region 10, and a portion where the porous portion 21A is not provided and the core portion 21B is exposed corresponds to the anode region 30. Accordingly, in the capacitor element 2 illustrated in FIG. 13A, the anode region 30 is provided in the cathode region 10.

As illustrated in FIGS. 13A and 13B, preferably, the through hole 50 is formed so as to extend through the anode region 30 in the thickness direction, and the through hole conductor 51 that extends in the thickness direction is provided in the through hole 50.

The through hole conductor 51 is, for example, electrically connected to the anode plate 21. In this case, as illustrated in FIG. 13A, in the anode region 30, the through hole conductor 51 is preferably electrically connected to the anode plate 21 of the cathode region 10 by connecting the through hole conductor 51 to the core portion 21B of the anode plate 21 at the inner wall of the through hole 50.

FIG. 14A is a sectional view schematically illustrating another example of the capacitor element according to the second embodiment of the present invention. FIG. 14B is a plan view taken along line B-B of FIG. 14A.

In a capacitor element 2A illustrated in FIG. 14A, as in the capacitor element 2 illustrated in FIG. 13A, the anode region 30 is provided in the cathode region 10.

As illustrated in FIGS. 14A and 14B, preferably, through holes 50 are formed so as to extend through the anode region 30 in the thickness direction, and through hole conductors 51 and 52 that extend in the thickness direction are provided in the through holes 50.

The through hole conductor 51 is, for example, electrically connected to the anode plate 21. In this case, as illustrated in FIG. 14A, in the anode region 30, the through hole conductor 51 is preferably electrically connected to the anode plate 21 of the cathode region 10 by connecting the through hole conductor 51 to the core portion 21B of the anode plate 21 at the inner wall of the through hole 50.

The through hole conductor 52 is not electrically connected to, for example, the anode plate 21. In this case, the through hole conductor 52 may be electrically connected to the cathode layer 23 or is not necessarily electrically connected to the cathode layer 23. Preferably, an insulating material such as a sealing layer 11 is filled into a space between the through hole conductor 52 and the through hole 50.

With the capacitor element 2A illustrated in FIG. 14A, versatility of electrode design can be improved.

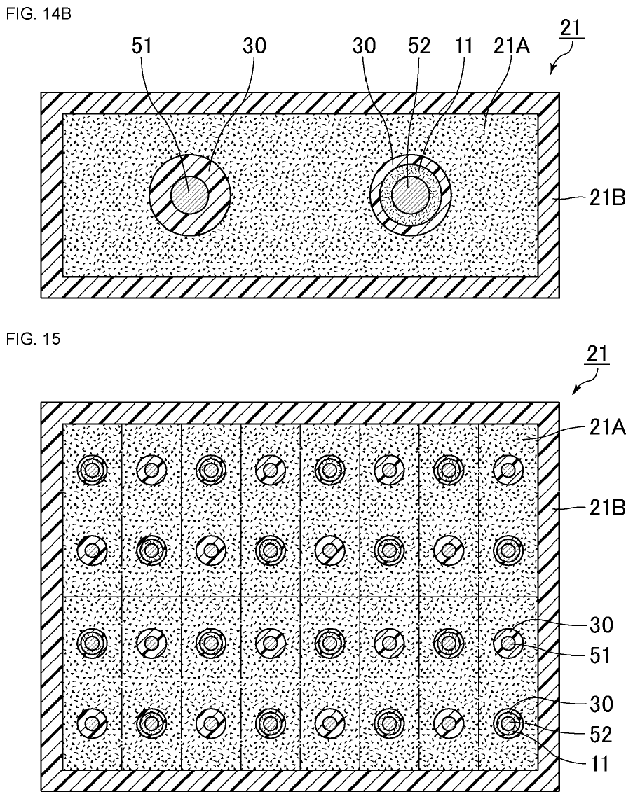

FIG. 15 is a plan view schematically illustrating a modification of arrangement of the through hole conductors in the capacitor element according to the second embodiment of the present invention.

In the example illustrated in FIG. 15, the through holes 50 are formed so as to extend through, in the thickness direction, the anode region 30 provided in the cathode region 10, and a plurality of the through hole conductors 51 and a plurality of the through hole conductors 52 that extend in the thickness direction are provided in the through holes 50.

As illustrated in FIG. 15, in the cathode region 10, there may be a plurality of (preferably, an even number of) units each including a set of the through hole conductor 51 electrically connected to the anode plate 21 and the through hole conductor 52 not electrically connected to the anode plate 21. In this case, preferably, the number of the through hole conductors 51 existing in the cathode region 10 and the number of the through hole conductors 52 existing in the cathode region 10 are the same.

### Other Embodiments

The capacitor element according to the present invention is not limited to the above-described embodiments. Regarding the configuration, manufacturing conditions, and so forth of the capacitor element, various applications and modifications can be added without departing from the scope of the present invention.

For example, when the capacitor element has a plurality of the cathode regions, the anode region may be provided so as to keep the adjacent cathode regions to be separated from each other as described according to the first embodiment in addition to the anode region provided in the cathode region as described according to the second embodiment.

### [Composite Electronic Component]

The capacitor element according to the present invention can be preferably used as a constituent of a composite electronic component. Such a composite electronic component includes, for example, the capacitor element according to the present invention, an outer electrode that is provided in an outer side portion of the above-described capacitor element (preferably in the outer side portion of the sealing layer of the capacitor element) and electrically connected to the anode plate and the cathode layer of the capacitor element, and an electronic component connected to the outer electrode.

The electronic component in the composite electronic component connected to the outer electrode may be a passive component or an active component. Either or both of the passive component and the active component may be connected to the outer electrode. Furthermore, a composite of the passive component and the active component may be connected to the outer electrode.

Examples of the passive component include, for example, an inductor and so forth. Examples of the active component include a memory, a graphical processing unit (GPU), a central processing unit (CPU), a micro processing unit (MPU), a power management integrated circuit (PMIC), and so forth.

The capacitor element according to the present invention generally has a sheet shape. Thus, the capacitor element can be handled similarly to a mounting board in the composite electronic component, and the electronic component can be mounted on the capacitor element. Furthermore, when electronic components mounted on the capacitor element have a sheet shape, the capacitor element and the electronic components can be connected to each other in the thickness direction via the through hole conductor extending through each electronic component in the thickness direction. As a result, the active component and the passive component can be configured similarly to an integral module.

For example, a switching regulator can be formed by electrically connecting the capacitor element according to the present invention between a voltage regulator including a semiconductor active component and a load to which a converted direct-current voltage is supplied.

In a composite electronic component, a circuit layer may be formed in one of surfaces of a capacitor matrix sheet in which a plurality of the capacitor elements according to the present invention are laid out, and then, the capacitor elements may be connected to the passive component or the active component.

The capacitor element according to the present invention may be disposed in a cavity portion provided in a board in advance, and the cavity portion may be filled with resin, and then a circuit layer may be formed on the resin. Another electronic component (a passive component or an active component) may be placed in another cavity portion of the same board.

Alternatively, the capacitor element according to the present invention may be placed on a smooth carrier such as a wafer or a glass, an outer layer portion may be formed with resin, a circuit layer is formed, and then, the capacitor element is connected to a passive component or an active component.

### REFERENCE SIGNS LIST

1, 1A, 1B, 1C, 1D, 1E, 1F, 1G, 2, 2A capacitor element
10, 10A, 10B cathode region
11 sealing layer
12 first outer electrode (outer electrode)
13 second outer electrode (outer electrode)
21 anode plate
21A porous portion
21B core portion
22 dielectric layer
23 cathode layer
23A solid-electrolyte layer
23B conductor layer
30 anode region
40 insulating layer
50 through hole
51, 52 through hole conductor
60 slit

1. A capacitor element having a cathode region and an anode region in a plan view thereof, the capacitor element comprising:
an anode plate in at least the anode region;
a porous portion composed of a valve metal in the cathode region and not in the anode region;
a dielectric layer on a surface of the porous portion in the cathode region; and
a cathode layer on a surface of the dielectric layer in the cathode region, the cathode layer including a solid-electrolyte layer.

2. The capacitor element according to claim 1, further comprising:
a first outer electrode electrically connected to a core portion of the anode plate in the anode region.

3. The capacitor element according to claim 2, further comprising:
a second outer electrode electrically connected to the cathode layer in the cathode region.

4. The capacitor element according to claim 2, wherein, in the anode region, the porous portion is not provided in a region of the core portion to which the outer electrode is electrically connected.

5. The capacitor element according to claim 2, wherein, in the anode region, the core portion is electrically connected directly to the outer electrode.

6. The capacitor element according to claim 1, wherein the anode region is extends to a position of a surface of the porous portion in the cathode region.

7. The capacitor element according to claim 1, wherein the anode region is at a position higher than a surface of the porous portion in the cathode region.

8. The capacitor element according to claim 1, wherein the anode region is at a position higher than a surface of the porous portion in the cathode region by greater than or equal to 10% of a total thickness of the porous portion.

9. The capacitor element according to claim 1, wherein the anode region is at a position lower than a surface of the porous portion in the cathode region.

10. The capacitor element according to claim 1, wherein the anode plate extends into the cathode region and is a core portion thereof, and the porous portion is on at least one main surface of the core portion.

11. The capacitor element according to claim 10, wherein a thickness of the anode plate in the anode region is equivalent to a thickness of the core portion in the cathode region.

12. The capacitor element according to claim 1, wherein the anode plate does not extend into the cathode region.

13. The capacitor element according to claim 1, further comprising an insulating layer on the at least one main surface of the anode plate in the anode region.

14. The capacitor element according to claim 13, wherein part of the insulating layer is filled into a pore of the porous portion in the cathode region.

15. The capacitor element according to claim 1, wherein
a through hole extends through the anode region in a thickness direction of the capacitor element, and
the capacitor element further comprises a through hole conductor extending in the thickness direction in the through hole.

16. The capacitor element according to claim 15, wherein the through hole conductor is electrically connected to a core portion of the anode plate at an inner wall of the through hole.

17. The capacitor element according to claim 1, wherein a slit extends through the anode plate in a thickness direction in the anode region.

18. The capacitor element according to claim 1, further comprising a conductor layer on the solid electrolyte layer in the cathode region.

19. The capacitor element according to claim 1, wherein the cathode region is a first cathode region, the porous portion is a first porous portion, the dielectric layer is a first dielectric layer, the cathode layer is a first cathode layer, and the solid electrolyte layer is a first solid electrolyte layer, the capacitor element further having a second cathode region adjacent to the first cathode region and separated by the anode region, the capacitor element further including:
a second porous portion composed of the valve metal in the second cathode region and not in the anode region;
a second dielectric layer on a surface of the second porous portion in the second cathode region; and
a second cathode layer on a surface of the second dielectric layer in the second cathode region, the second cathode layer including a second solid-electrolyte layer.

20. The capacitor element according to claim 1, wherein the anode region is in the cathode region.
